(19) United States
(12) Patent Application Publication
(10) Pub. No.: US 2026/0300456 A1
(43) Pub. Date: Oct. 1, 2026

(54) Secure Access Control System for Digital Cameras and Camcorders

(71) Applicants: Christohper T.R. Smith, Millsboro, DE (US); Stephone M Belton, Randallstown, MD (US)

(72) Inventors: Christohper T.R. Smith, Millsboro, DE (US); Stephone M Belton, Randallstown, MD (US)

(21) Appl. No.: 19/094,838

(22) Filed: Mar. 29, 2025

(51) Int. Cl. G06F 21/32

(52) U.S. Cl. CPC G06F 21/32

(57) ABSTRACT

Disclosed herein is a secure access control system for digital cameras and camcorders designed to prevent unauthorized use of the device by restricting access to core functionalities. The system supports one or more authentication methods, including numeric or alphanumeric PINs, biometric identifiers (such as fingerprint, facial recognition, or retina scanning), and visual authentication methods (such as QR codes or barcodes). Upon successful authentication, users are granted access to essential camera operations, including image capture, video recording, settings adjustment, and menu navigation. The system may also be configured to prompt for re-authentication based on power cycles or timed intervals, maintaining security without compromising usability. An integrated encryption module ensures authentication data is securely processed and stored within the device. Unlike conventional security measures, this invention offers a flexible and integrated access control system, delivering a practical and scalable approach to access control in standalone digital imaging devices.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The present invention relates to security and access control systems for electronic imaging devices, specifically digital cameras and camcorders. It encompasses methods and apparatus for restricting access to a camera's core functionalities using authentication methods, including PIN-based entry, biometric verification, and visual scanning.

### Description of the Related Art

Current security and access control methods for digital cameras and camcorders typically rely on external devices, basic password systems, or general software solutions originally intended for computer peripherals and webcams. Existing patents such as U.S.20210306343A1 (“System for transferring security access permissions between in-camera users”) focus on permission transfer between users via gestures and facial recognition but do not directly address securing individual camera functionalities with internal integrated authentication methods.

Similarly, patents such as U.S.20120151606A1 (“Software system for denying remote access to computer cameras”) focus exclusively on preventing unauthorized webcam access via software running on external computing devices, rather than integrating hardware-level security directly into standalone camera devices.

Additionally, systems described in patents such as U.S. Pat. No. 6,133,941A (“Camera control server issuing control authority to clients”), U.S. Pat. No. 9,183,361B2 (“Resource access authorization”), and U.S.20010024233A1 (“Camera control systems with region-based image pickup inhibition”) emphasize remote control access, server-client interactions, and regional limitations in image capture. These solutions do not specifically protect access to core camera functionality or stored sensitive data within consumer or prosumer standalone digital cameras and camcorders. They rely significantly on external controls, server interactions, or user interfaces that are impractical for portable, standalone imaging devices.

In clear distinction, the present invention provides an integrated, comprehensive, and flexible access control system specifically designed for standalone consumer and prosumer digital cameras and camcorders. It uniquely enables configurable authentication using one or more methods—such as numeric or alphanumeric PIN entry, biometric verification (including fingerprint, facial recognition, or retina scanning), and visual code scanning (e.g., QR codes or barcodes)—all implemented within the internal architecture of the camera device itself. The system further includes an integrated encryption module that protects authentication data during storage and processing, minimizing exposure to unauthorized access or tampering. Additionally, the invention supports adaptive, user-defined security preferences, including authentication prompts triggered by power cycles, periods of inactivity, or scheduled intervals. Optional enterprise integration with external authentication platforms is also supported, allowing centralized access control for professional or organizational use cases.

This invention addresses clear market gaps identified in the prior art by providing an internally integrated, flexible, and robust security framework that significantly improves upon previous solutions. It ensures high-level security for sensitive stored data, user-friendly access control mechanisms, and comprehensive protection of critical camera functionalities, without reliance on external devices or separate computing hardware.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The present invention seeks to improve prior techniques and provide enhanced security system for digital cameras and camcorders, ensuring access is restricted to authorized users only.

“It is also the objective of the invention to support a configurable authentication framework that allows for one or more methods, including PIN codes, biometric verification, and visual scanning.”

A further objective of the present invention is to prevent unauthorized access to the camera device and its functionalities, ensuring that only authenticated users can operate the system.

It is also an object of the invention to offer flexible authentication refresh options, including power cycle-based and timed re-authentication settings.

It is further the objective of the invention to enable seamless user authentication without significantly impacting device usability and user experience.

It is also the objective of the invention to prevent unauthorized individuals from tampering with device settings, ensuring operational integrity.

The objective of the invention is to enhance device security by encrypting the storage and processing of authentication credentials, ensuring only authorized users can operate the camera.

The invention may optionally support integration with external security management systems, providing centralized control for enterprise or professional use cases where needed.

It is further the objective of the invention to reduce the risk of device theft-related data breaches by locking the device against unauthorized users.

The invention aims to offer an adaptable security framework applicable to future digital imaging devices and related technologies.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention relates to a secure access control system for digital cameras and camcorders. The system ensures that only authorized users can access the device's core functionalities, including image capture, video recording, menu navigation, and settings adjustments. By implementing one or more authentication methods, the invention significantly enhances security, thereby preventing unauthorized use and protecting sensitive data.

As per its preferred embodiments, the secure access control system is designed to operate seamlessly with various forms of authentication, including PIN-based entry, biometric verification, and visual code scanning. The authentication process begins when the user attempts to access the camera's primary functions. The system prompts the user to enter a valid authentication credential, such as a numeric or alphanumeric PIN, fingerprint scan, facial recognition, retina scan, or a visual code scan (e.g., QR code or barcode). Once the input is received, the system validates the entered data against stored reference data. If the authentication is successful, access to the camera's functionalities is granted; otherwise, access is denied.

As per its further embodiments, the access control system includes an integrated encryption module that secures all authentication data during storage and internal processing. This encryption protects sensitive credentials—such as PIN codes or biometric identifiers—from interception or tampering. Additionally, as per its further embodiments, the system includes an authentication prompt that requires users to enter their credentials upon power-up or after a predetermined period of inactivity, thereby maintaining continuous access control and reinforcing security protocols.

As per its preferred embodiments, the invention incorporates a security check functionality that actively detects unauthorized access attempts. This security feature monitors authentication processes—such as PIN entry or biometric input—for signs of tampering, including multiple failed attempts or suspicious activity. Upon detection of such activity, the system may restrict access or temporarily lock the device and require additional verification, such as a backup PIN or biometric re-authentication, before allowing further operation. The system's response parameters may be configurable based on user preferences or manufacturer-defined policies.

As per its preferred embodiments, the secure access control system is integrated into the camera housing, ensuring a seamless and robust security mechanism. The housing encapsulates an optical conversion system responsible for transforming light images into digital data. Within this housing, a secondary security feature—implemented in hardware, software, or a combination thereof—is configured to restrict access to camera functionalities. This security feature may operate independently of the primary camera controls, ensuring that authentication is required before the camera can be used. The access control mechanism may include one or more authentication methods, such as PIN entry, biometric verification, or visual code scanning, which are used to verify the identity of the user before granting access to the device's functionalities.

As per its preferred embodiments, the system allows for configurable levels of access control based on predefined rules. Users may define access permissions according to their preferences, enabling varying levels of security for specific camera functions. For example, a user may require biometric authentication for image capture while permitting PIN-based access for menu navigation. This level of customization makes the system highly adaptable to a wide range of use cases and user requirements.

As per its preferred embodiments, the access control mechanism includes a power cycle security feature that governs the frequency of authentication prompts. Users may configure the system to require authentication upon each power-up, following a specified period of inactivity, or at defined time-based intervals. This functionality helps ensure that, even if the camera is left unattended, unauthorized users are prevented from gaining access without re-authentication.

As per its preferred embodiments, the secure access control system may be configured to communicate with external security systems through a dedicated interface or connector. This capability allows the camera to be optionally integrated with external authentication databases or centralized access control platforms, enabling consistent security measures across multiple devices. Such integration may be beneficial in enterprise or professional environments where multiple authorized users require access to the same device under a unified security policy.

As per its preferred embodiments, the invention further includes an adaptive security protocol configured to respond to repeated authentication failures. Upon detection of multiple unsuccessful access attempts, the system may implement countermeasures such as temporarily disabling authentication inputs, notifying a registered user through an external device, or activating a fail safe lockout mode. These measures are designed to deter brute force attacks and prevent unauthorized access to the camera.

As per its preferred embodiments, the invention provides an advanced security framework for consumer and prosumer digital cameras and camcorders, supporting one or more authentication methods within a secure access control system. Features such as encryption of authentication data, security monitoring functions, configurable access levels, and optional integration with external security systems contribute to a robust and adaptable solution. The system is designed to protect digital imaging devices from unauthorized use while maintaining straightforward access for authorized users.

The accompanying drawings are provided for illustrative purposes only and are not intended to limit the scope of the invention. Variations in layout, format, and implementation are possible without departing from the inventive concepts described herein.

Provided images can further understand the invention.

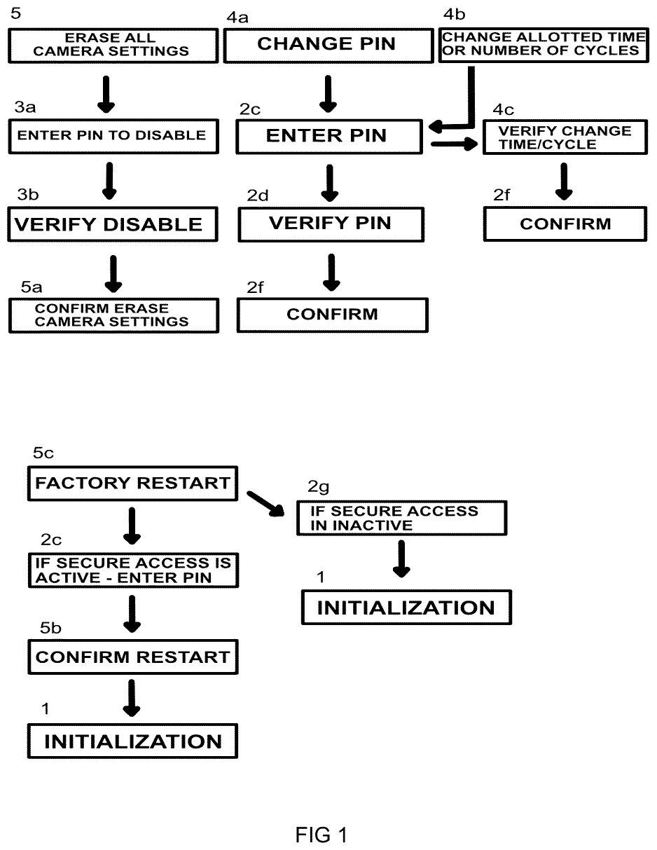

FIG. 1 illustrates a secure access control system focusing on PIN management, security settings modification, and factory reset options. The flowchart starts with steps to disable secure access, requiring a PIN entry (Step 3a) and verification (Step 3b) before confirming the action. There are additional options for modifying security settings, such as changing the PIN (Step 4a) and adjusting the allotted time or number of cycles (Step 4b), which require verification (Step 4c) before final confirmation. A critical feature in the flowchart is the factory reset (Step 5c), which restores the system to its original state. If secure access is active, the user must enter a PIN (Step 2c) before confirming the restart (Step 5b), after which the system undergoes initialization (Step 1). However, if secure access is inactive, the system can be initialized directly (Step 2g→Step 1). The flowchart also includes an option to erase all camera settings (Step 5), ensuring a comprehensive reset. This diagram primarily focuses on managing security credentials and resetting system settings while maintaining a structured verification process.

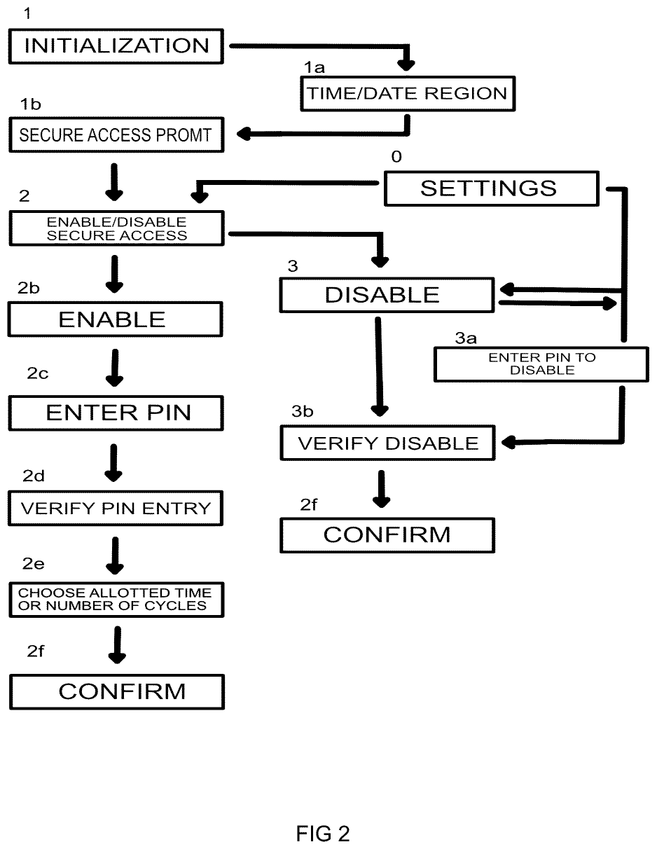

FIG. 2 represents the initialization and secure access configuration process, detailing how users can enable or disable secure access. The system begins with initialization (Step 1), followed by setting up the time, date, and region (Step 1a). A secure access prompt (Step 1b) appears, allowing users to proceed with enabling or disabling security features. To enable secure access (Step 2b), users must enter a PIN (Step 2c), which is verified (Step 2d), followed by choosing an allotted time or cycle limit (Step 2e) before confirming the configuration (Step 2f). Alternatively, the system allows users to disable secure access (Step 3), requiring them to enter their PIN (Step 3a), verify the action (Step 3b), and confirm it (Step 2f). The flowchart provides a clear sequence of steps to ensure security is managed efficiently while allowing customization of access settings. Unlike the first image, which focuses on resetting and modifying security settings, this diagram highlights the initial setup and activation of security features, ensuring that users can customize access controls as per their needs.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A camera device, comprising:
A secure access control system operatively integrated within or associated with the camera housing, configured to internally restrict access to core functionalities of the camera device;
A secure authentication input assembly configured to receive and securely process authentication credentials provided directly by a user, wherein said authentication credentials comprise one or more of numeric PINs, alphanumeric PINs, biometric identifiers including fingerprint, facial recognition, retina scanning, and visual codes including QR codes and barcodes;
A controller configured to internally store reference authentication credentials, authenticate the received authentication credentials by comparing them to said stored reference credentials, and subsequently grant or deny access to core camera functionalities including image capture, video recording, menu navigation, and settings adjustments based on successful authentication; and
An encryption module configured to encrypt and decrypt authentication credentials during storage and internal processing, thereby protecting sensitive credential data from unauthorized interception or tampering;
Wherein the camera device is selected from the group consisting of large-sensor compact cameras, camcorders, large format cameras, film cameras with digital display, rangefinder cameras, 360-degree cameras, medium format cameras, compact system cameras (CSC), action cameras, point-and-shoot cameras, cinema cameras, mirrorless cameras, digital single-lens reflex (DSLR) cameras, and other consumer or prosumer standalone optical imaging devices primarily intended for capturing and recording images or video, while explicitly excluding security cameras, surveillance systems, and monitoring devices.

2. The device of claim 1, further comprising:
An authentication prompt system configured to prompt the user for authentication input before granting access to camera functionalities, wherein said authentication prompt is activated upon device power-up, following a predetermined period of inactivity, or upon user-defined security conditions.

3. The device of claim 1, wherein the PIN entry system further includes:
A PIN entry prompt, wherein said prompt is activated only after a predetermined security check is completed;
A security check functionality operative to detect unauthorized access or eavesdropping attempts during PIN entry and to prevent further operations unless the security check passes.

4. The device of claim 1, wherein the secure access control system is operatively associated with the camera or camcorder, including within or in association with the housing, and is configured
to restrict access to one or more of the following functions: image capture, video recording, menu navigation, or settings adjustments, until successful authentication is completed.

5. A camera housing for a digital camera or camcorder, comprising:
An integrated optical conversion system configured to convert light images into digital image data;
A housing that encapsulates said optical conversion system and associated electronic components;
A secondary security feature operatively associated with the housing and configured to limit access to the camera's functionalities, the security feature comprising:
At least one access control mechanism selected from the group consisting of PIN entry, biometric authentication, and visual code scanning;
Wherein the access control mechanism restricts use of the camera unless the user is successfully authenticated.

6. The housing of claim 5, wherein the access control mechanism includes a PIN entry assembly capable of accepting a user-input PIN comprising numeric characters, alphanumeric characters, symbols, or combinations thereof.

7. The housing of claim 5, wherein the biometric authentication comprises at least one biometric identifier selected from the group consisting of fingerprint recognition, facial recognition, retina scanning, or any other suitable biometric modality.

8. The housing of claim 5, wherein the visual code scanning comprises scanning of QR codes, barcodes, or any other graphical symbol capable of being interpreted by the camera's integrated system.

9. The device of claim 1, wherein the secure access control system is configured to prevent unauthorized use of the camera's functions, menus, or settings through the use of one or more authentication methods selected from the group consisting of numeric PINs, alphanumeric PINs, biometric identifiers, and visual code-based inputs.

10. A method for securing access to a digital camera or camcorder, comprising the steps of:
Receiving one or more authentication inputs from a user, the inputs comprising at least one of a PIN, biometric data, or visual code; Validating the received input against stored reference data;
Encrypting the authentication data to ensure privacy and security during processing;
Permitting access to one or more camera functions, including image capture, video recording, and menu navigation, upon successful authentication;
Restricting access to said camera functions until authentication is successfully completed.

11. The method of claim 10, further comprising the step of performing a security check to detect unauthorized access attempts or tampering during the authentication process, including but not limited to repeated failed entries or suspicious activity associated with the input of authentication credentials.

12. The method of claim 10, wherein access to the camera's functions is secured using one or more authentication methods selected from the group consisting of PIN entry, biometric verification, and visual code scanning, and wherein unauthorized access attempts trigger a security protocol.

13. The device of claim 1, wherein the system is further configured to allow or restrict access based on predefined access rules, thereby enabling different levels of functionality to be granted to different categories of users.

14. A device for securing a digital camera or camcorder, comprising:
A processor configured to execute software for handling authentication operations, including PIN entry;
A memory configured to store encryption keys for securely encrypting and decrypting authentication data;
A secure input interface capable of accepting numeric, alphanumeric, symbolic, or combination-based PIN inputs;
An encryption module configured to encrypt the entered authentication data;
A decryption module configured to decrypt the authentication data upon successful verification, thereby enabling access to the device's functionalities.

15. The device of claim 14, wherein the secure access control system may be configured to communicate with external security systems via a physical or wireless communication interface, to support centralized user authentication or enterprise-level access management.
